(19) United States
(12) Patent Application Publication
(10) Pub. No.: US 2014/0126839 A1
(43) Pub. Date: May 8, 2014

(54) DEFECT DETECTION USING JOINT ALIGNMENT AND DEFECT EXTRACTION

(71) Applicant: SHARP LABORATORIES OF AMERICA, INC., Camas, WA (US)

(72) Inventors: Zhen QIN, Riverside, CA (US); Petrus J.L. VAN BEEK, Camas, WA (US)

(73) Assignee: SHARP LABORATORIES OF AMERICA, INC., Camas, WA (US)

(21) Appl. No.: 13/672,104

(22) Filed: Nov. 8, 2012

(51) Int. Cl. G06T 3/00

(52) U.S. Cl. CPC G06T 3/0068
USPC 382/294

(57) ABSTRACT

A technique for image processing that includes receiving a model image, an input image, and registering the input image with the model image. A modified input image is determined that includes a first component that is substantially free of error components with respect to the model image and a second component that is substantially free of non-error aspects with respect to the model image. The technique determines an improved alignment of the modified input image with the model image where the improved alignment and the first and second components are determined jointly.

### CROSS-REFERENCE TO RELATED APPLICATIONS

None.

### BACKGROUND OF THE INVENTION

The present invention relates generally to template matching and template-based defect detection for an image.

Referring to FIG. 1, template matching is a commonly used technique in order to perform alignment between multiple images or to recognize content in an image. The template matching technique includes a given target object in a model image, and automatically finding the position, orientation, and scaling of the target object in input images. Generally, the input images undergo geometric transforms (translation, rotation, zoom, etc) and photometric changes (brightness/contrast changes, blur, noise, etc). In the context of template matching and defect detection, the relevant characteristics of the target object in the model image may be assumed to be known before the template matching to the target image is performed. The target object in the model image is generally considered to contain an “ideal” and “defect-free” view of the product or parts of the product. Such characteristics of the target object may be extracted, modeled, and learned previously in a manner that may be considered “off-line,” while the matching of those characteristics to the input image may be considered “on-line.” Thus, the input image contains a view of the product under inspection and is compared with the template image to align the two images and to detect defects. In principal, deviations or differences from the template image present in the input image may indicate one or more defects.

One type of alignment technique includes feature point based alignment which achieves good matching accuracy. Feature point based alignment extracts discriminative interesting points and features from the model image and the input images. Then those features are matched between the model image and the input images with K-nearest neighbor search or some feature point classification technique. Then a homography transformation is estimated from those matched feature points, which may further be refined.

Feature point based alignment works well when target objects contain a sufficient number of interesting feature points. Feature point based alignment typically fails to produce a valid homography when the target object in the input or model image contains few or no interesting points (e.g. corners), or the target object is very simple (e.g. target object consists of only edges, like paper clip) or symmetric, and/or the target object contains repetitive patterns (e.g. machine screw). In these situations, too many ambiguous matches prevents generating a valid homography. To reduce the likelihood of such failure, global information of the object such as edges, contours, or shape may be utilized instead of merely relying on local features.

Another type of alignment technique is to search for the target object by sliding a window of a reference template in a point-by-point manner, and computing the degree of similarity between them, where the similarity metric is commonly given by correlation or normalized cross correlation. Pixel-based template matching is very time-consuming and computationally expensive. For an input image of size N×N and the model image of size W×W, the computational complexity is O(W²×N²), given that the object orientation in both the input and model image is coincident. When searching for an object with arbitrary orientation, one technique is to do template matching with the model image rotated in every possible orientation, which makes the matching scheme far more computationally expensive.

What is desired therefore is a computationally efficient image alignment and defect detection technique.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates template matching.

FIG. 2 illustrates a model image, an input image, and an output image.

FIG. 3 illustrates another model image, an input image, and an output image.

FIG. 4 illustrates another model image, an input image, and an output image.

FIGS. 5A-5D illustrate various defects.

FIG. 6 illustrates a template based technique.

FIG. 7 illustrates a modified template based technique.

FIG. 8 illustrates an optimization technique for template matching.

FIG. 9 illustrates an embodiment of direct factorization and alignment refinement for template matching.

FIG. 10 illustrates an embodiment of another aspect of direct factorization and alignment refinement for template matching.

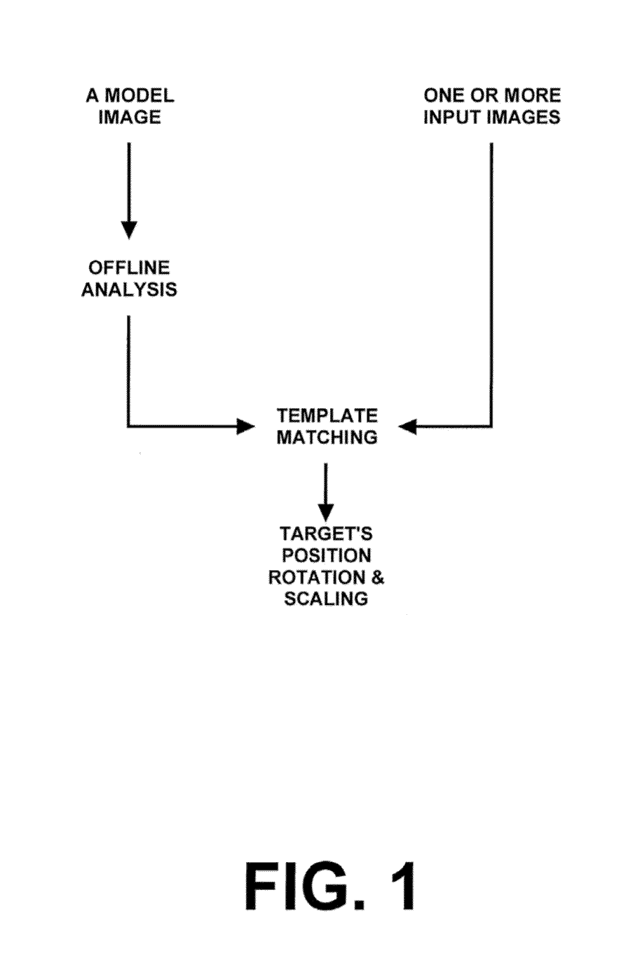

### DETAILED DESCRIPTION OF PREFERRED EMBODIMENT

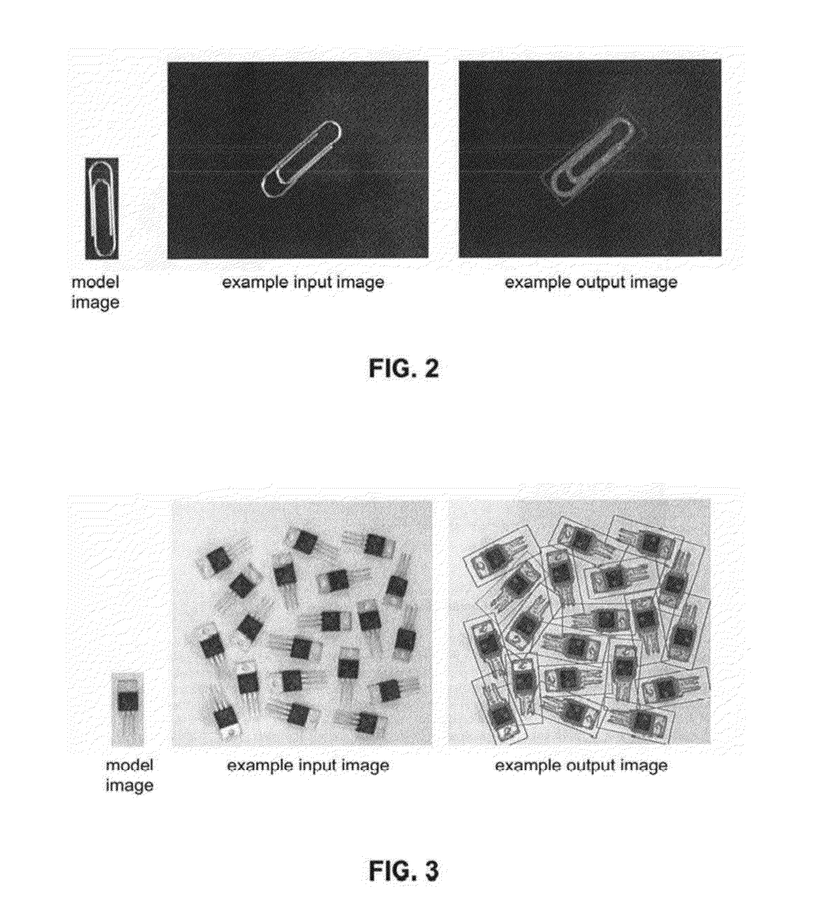

Referring to FIG. 2, in many cases a model image has a limited set of feature points but tends to have relatively sharp edge features. One such example is a paperclip. Then using a suitable matching technique it is desirable to find a matching object in one or more input images, in a computationally efficient manner. The matching object may be at an unknown position and at an unknown rotation.

Referring to FIG. 3, in many cases the input image may have one or more matching objects of interest, which may be overlapping with one another. Then using a suitable matching technique it is desirable to find matching objects in one or more input images, in a computationally efficient manner. The matching objects may be at an unknown position and at an unknown rotation.

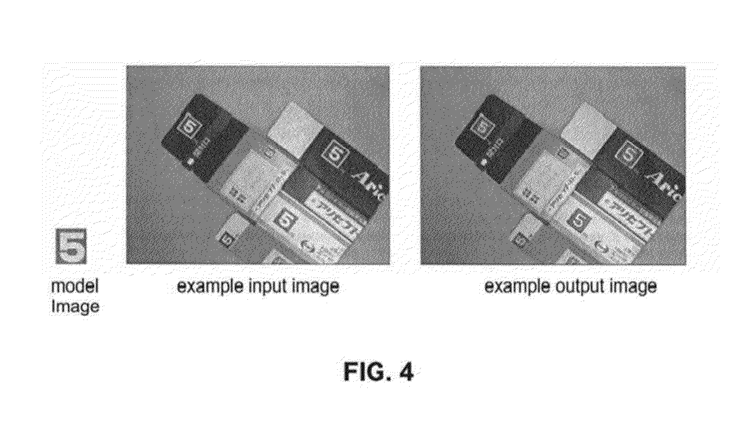

Referring to FIG. 4, in many cases the input image may have one or more matching objects of interest, which may be overlapping with one another. Then using a suitable matching technique it is desirable to find matching objects in one or more input images, in a computationally efficient manner. The matching object may be at an unknown position, unknown rotation, and unknown scale.

Referring again to FIG. 2, FIG. 3, and FIG. 4, the matching technique should be computationally efficient, while being sufficiently robust to distinguish image features such as sharp corners, significant edges, or distinguish images with relatively few such features. Moreover, the matching technique should be sufficiently robust to reduce effects due to lighting or illumination changes in the image, blur in the image, noise in the image, and other imaging imperfections.

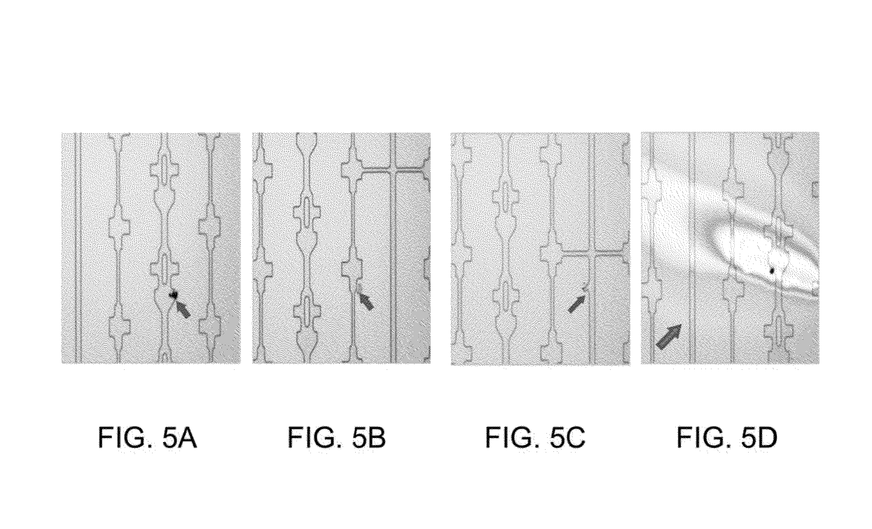

Referring to FIG. 5A, an exemplary defect from a liquid crystal panel is illustrated that has an arbitrary shape. Referring to FIG. 5B, an exemplary defect from a liquid crystal panel is illustrated that has a weak intensity. Referring to FIG. 5C, an exemplary defect from a liquid crystal panel is illustrated that is generally specific to the object class being examined. Referring to FIG. 5D, an exemplary defect from a liquid crystal panel is illustrated that is relatively large is size and has the general characteristics of a gradual change in color. As illustrated in such examples, the defects are highly variable in terms of appearance, size, type, and may be specific to the object class being inspected. In each of these examples, it would be desirable to be able to accurately detect the defect using a generalized and robust system that is suitable for different defects and even previously unknown defects.

The preferable technique for the detection of defects in the input image is using a template difference based detection framework. As a general matter, a template difference based technique may make few, if any, assumptions about the object defect being processed, and generally seeks the differences between an inspected image and a defect-free template. Such limited assumptions are useful because real-world defects tend to be extraordinarily diverse in nature. Further, the technique should be suitable for a generalized class of inspected images for different types of defects, including previously uncharacterized defects and datasets. Such template difference based techniques may need limited, if any, training data. Rather than training data, a “defect-free” template model image is preferable. For example, a “defect-free” LCD panel image may be used as the model image, though such model images generally do not tend to be absolutely perfect.

In such a template difference based technique, the inspected image may be initially registered with a portion of a generally larger defect-free template using a registration technique which is traditionally, followed by a difference based technique, such as for example, grey-level difference technique, optical flow difference technique, normalized cross correlation (NCC) difference technique, wavelet-based difference technique, and/or Hausdorff distance difference technique. Unfortunately, such defect detection techniques are still largely ad-hoc and tend to be focused at particular applications, tend to be undefined for uniform surfaces, tend to require excessive training, tend to require manual intervention, tend to be applicable only for defects of a small size, and/or tend to be sensitive to parameter settings.

Many of the limitations of the aforementioned techniques result from unsuitable assumptions. For example, the assumption of the existence of some fixed landmark points restricts some techniques to a specific application scenario. More importantly, one assumption made by such techniques is an unrealistic view of the accuracy of the registration and the alignment. Often to alleviate such alignment assumptions manual adjustment is performed (and then perfect alignment is assumed for the remainder of the processing), to alleviate such alignment assumptions only relatively small defects are determined (which reduces alignment tolerances), and/or to alleviate such alignment assumptions non-trivial pre/post-processing procedures are applied which tend to degenerate or even fail the detection procedure. These limitations also tend to introduce additional complexity making such systems problematic for industrial operators with limited training. To improve the defect detection a more accurate alignment is desirable that is not readily skewed by the existence of defects.

In general, the template matching technique should conduct a joint alignment refinement process while accounting for defects using an error measurement. This pair of otherwise contrasting goals may be achieved by decomposing a template-guided image matrix simultaneously into a low-rank part relating to aligned “defect-free” images and an error component accessible for defect mask generation. The separation of an image into a lower rank image may be performed for the input image and the model image, or just one of the images, if desired.

The preferred template based technique may be based upon a direct matrix factorization and alignment refinement. The technique may iteratively improve both the alignment and the defect detection using any suitable technique, including a decomposable structure. The use of the direct matrix factorization for defect detection addresses the dilemma between the previously contradictory goals of alignment and defect detection. The technique may be formulated as an outlier detection in a low-rank representation of a template-guided image matrix which alleviates the assumptions on the behavior of objects and defects, permitting the technique to be useful for many different applications. The trade-off between accuracy and speed for image down-sampling does not necessarily hold when dealing problems in real-world industrial scenarios where small local deviations exist between the template and inspected image.

The direct factorization technique may be implemented without requiring training and include accurate alignment and defect localization to relieve the need for nontrivial pre/post-processing procedures and computationally complex alignment techniques. The system may be implemented in a manner suitable for industrial operators by including a limited number of parameters that may be selected.

The direct factorization technique may include rank minimization technique that typically includes a collection of images of an object that are considered to contain common principle components that are linearly correlated. However, the observed image data is corrupted by the effects of illumination, occlusion, defects, or other changes. Thus the observed images or image patches may be treated as vectors and stacked together in a matrix. Recovering the linearly correlated components is related to minimizing the rank of the matrix. In addition, the errors in the observed image data relative to the principle components are explicitly modeled and considered to be sparse. This sparsity of the error in this optimization formulation may be enforced in any suitable manner, such as using the l₀ pseudo-norm or the l₁ norm. The system may substantially recover, or exactly recover, low-rank matrices despite significant corruption in an efficient way, even when entry-wise noise exists. Such techniques may relax the formulation of optimizing the rank and l₀ norm to optimizing the nuclear norm and l₁ norm. In other cases, the technique may not necessarily require such relaxations and direct factorization may be used. Preferably, the technique is applied to a single input image and a single template. Preferably a template-guided matrix is decomposed that guides the low-rank part towards the template while relaxing the sparsity assumption of the defects. In addition, the system preferably considers noise and is fully automatic without the need to label feature points.

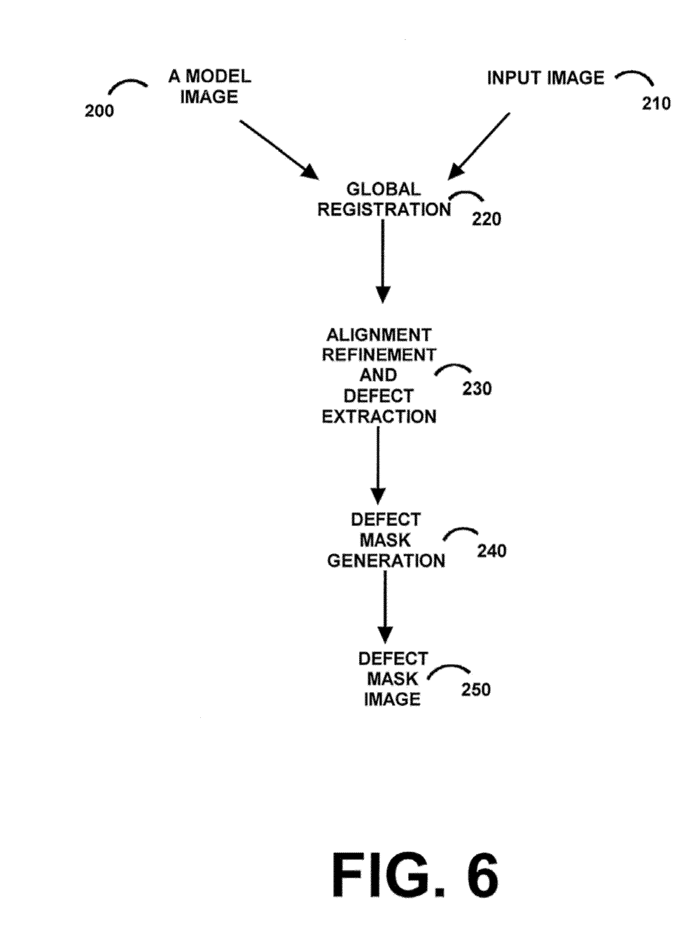

Referring to FIG. 6, an exemplary defect detection system receives a model image 200 and an input image 210. A global registration 220 generally aligns the input image 210 with a portion of the model image 200. Typically the input image is representative of only a portion of the model image. For example, the global registration may use an edge feature based matching technique. The globally aligned model and input images are then jointly refined in their alignment together with defect extraction 230, preferably in a “simultaneous” manner. After refining the alignment and extracting a defect image 230, defect mask generation 240 detects the final defect areas. The defect locations and regions are identified by a defect mask image 250.

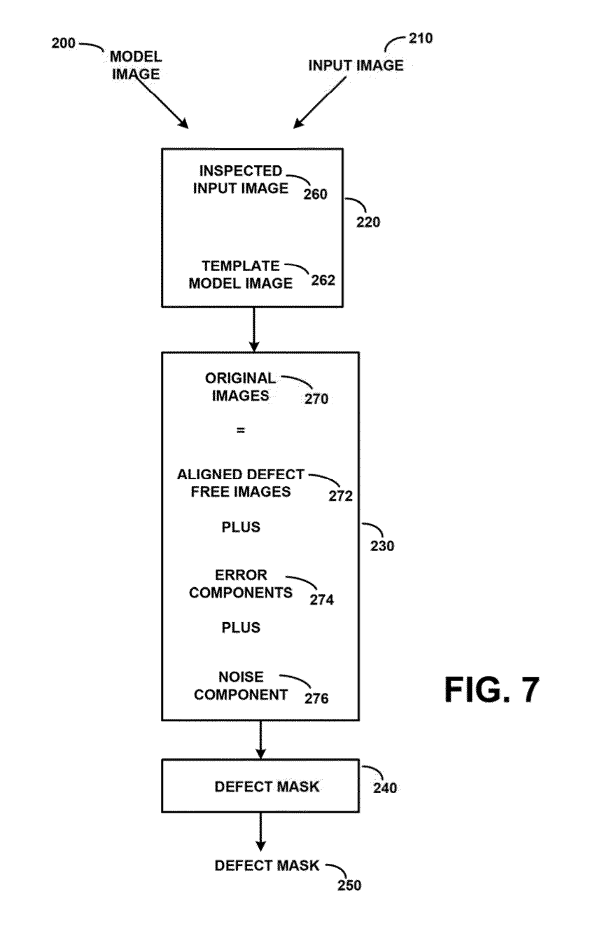

Referring to FIG. 7, the system may use a hierarchical framework that roughly locates the inspected input image candidate 260 within the template model image 262 using one or more techniques, such as an edge feature-based matching technique. Feature-based global registration techniques are computationally efficient. The global registration results in the template model image and input image being imperfectly aligned with one another. Subsequently, the joint alignment refinement and defect extraction 230 is used. The joint alignment and defect extraction decomposes these original images 270 into a first component containing well-aligned and defect free images 272, a second (or more) component representing error images containing the defects 274, and a noise component 276. The determination of the defect free component, error component, and noise component of the input images is based upon the corresponding portion of the model image. The extracted error component 274 effectively isolates the defects and is largely free of false detections that would otherwise occur due to imperfect alignment and other degradations in the inspection image or other imaging effects such as illumination changes and noise. Thus the defect free portions of the input image are compared to the respective portion of the model image (or a defect free representation thereof) so that an alignment is achieved without being skewed by the defects which are represented in the error component 274. The element/pixel values in the error component 274 are high in defect areas and low in other areas. The noise component 276 represents the noise in the images. Thereafter, a defect mask 280 is determined from the error component, for example, by using a thresholding technique.

An exemplary description of the defect detection given the input image and the corresponding (but not perfectly aligned) template image is described. Suppose one has the well-aligned, defect free single-channel input model image I₁⁰ and one or more copies of the template image I₂⁰, . . . , Iₙ⁰∈R^{w×h}, one may define vec: R^{w×h}→R^{m} as the stack of corresponding pixels as a vector. The single-channel images may, for example, be grayscale or luminance data, or simply contain the green channel of an RGB image. One may use multiple template images, if desired. The matrix formed out of these vectors:

A [symbol] [vec(I₁⁰)vec(Iₙ⁰)]∈R^{m×n}

should be low-rank. Matrix A represents the defect free images as a vector. Low-rank indicates that the input image should be linearly correlated with the template image(s). Another way to view it is that the columns of matrix A should be substantially the same regardless of global intensity change such as illumination, which is typical for the input image and the template image. To this point of the technique, it may assume perfect alignment and defect removal of the pair of images.

However, the observed images are neither well-aligned nor defect-free, which can be represented as Iᵢ=(Iᵢ⁰+eᵢ)·τᵢ⁻¹, where eᵢ is an additive error component wherein one intends the defects to be contained and is assumed to be sparse, where τᵢ⁻¹∈ [symbol] is the transformation that model the misalignment. I₁ represents the input image. Iᵢ⁰ represents the defect free portion of the input image. For example, G may include parametric representations of spatial transformations such as the similarity, the affine, and/or the planar homography group. For example, a similarity transformation includes spatial translation, rotation, scaling and reflection. The error component is expected to be sparse, indicating that relative few entries of the error component should have non-zero values.

Thus, it is desirable to decompose the globally aligned observed image matrix D·τ [symbol] [vec(I₁·τ₁)| . . . |vec(Iₙ·ρₙ)]∈R^{m×n} as D·τ=A+E+∈ where E [symbol] [vec(e₁)| . . . |vec(eₙ)]∈R^{m×n} and one uses ∈ to model entry-wise (pixel-wise) noise. In other words, it is desirable to decompose the aligned observed images (D·τ) into a low-rank component (A) which should relate to the defect-free background, an error component (E) expected to contain the defects, and a noise term (∈) modelling real-world entry-wise noise. Note that D represents the observed images before alignment.

A direct formulation of the problem can be posed as a constrained optimization problem as, min_{A,E,τ}∥D·τ−E−A∥_{F}, s. t. rank (A)≦K, ∥E∥₀≦γ, where K is the rank constraint on the low-rank approximation A, and γ is the maximal number of non-zero entries in E. In other words, the problem may be stated as finding the optimal low-rank component (A), error component (E) and alignment transforms (T) that minimize the additive noise (□), under the constraints that the rank of A is smaller than a threshold K and that the l₀ pseudo-norm is smaller than a threshold γ. The l₀ pseudo-norm measures the number of non-zero elements in E. Hence, the constraint on E represents the expectation that the error component should be sparse. This formulation can be viewed as an non-relaxed formulation of a robust rank minimization framework while considering noise. Intuitively, one can approximate the low-rank component, since (D·τ−E) can be viewed as the aligned image matrix excluding the defects. The characterization of the images for the direct factorization and alignment refinement may be directly solved in the primal form.

This relationship may be solved without relaxing either the rank or the sparsity constraint or referring to the Lagrangian. First, since the dependence of D·τ is based on the transformations τ, when the change in τ is small, one can approximate the dependency by linearizing about the current estimate of τ. Then the optimization problem becomes:

$${min}_{A , E , Δτ} {‖ D \cdot τ + {\sum }_{i = 1}^{n} {J}_{i} Δ {τ}_{i} {ɛ}_{i}^{T} - E - A ‖}_{F}$$

$$s . t . rank ( A ) \leq K$$

$${‖ E ‖}_{0} \leq γ$$

$$where {J}_{i} {=}^{def} \frac{\partial }{\partial δ} vec ( {I}_{i} \cdot δ ) {\vert}_{δ = {τ}_{i}}$$

is the Jacobian of the i-th image with respect to the transformation τᵢ and εᵢ is the i-th standard basis for for Rⁿ (aiming at a compact representation). Since the linearization holds locally, one may repeatedly linearize about the current transformations and solve the problem iteratively as formulated above.

Given the current estimate of transformations τ (the first one can be identity transform) and the corresponding Jacobian, one can take advantage of the decomposable structure of the formulation and apply block coordinate descent with respect to A, E and Δτ.

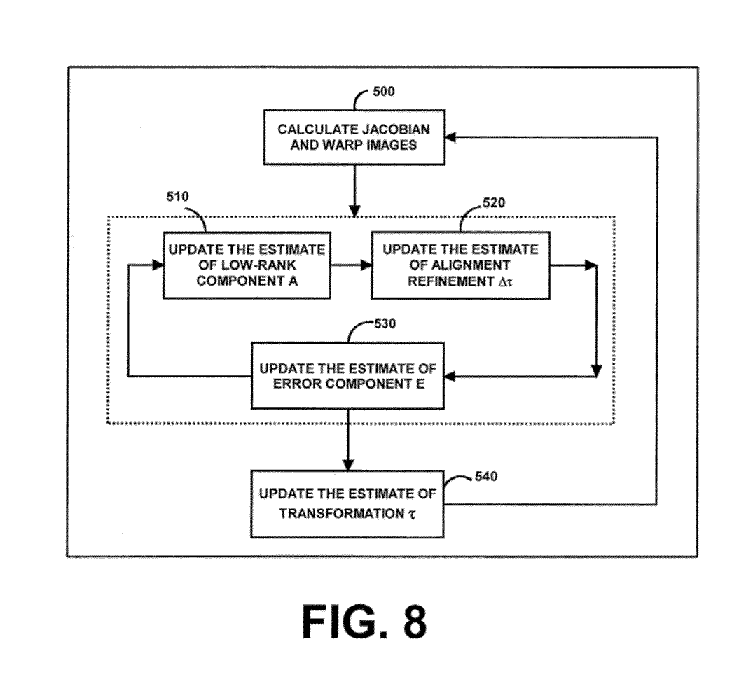

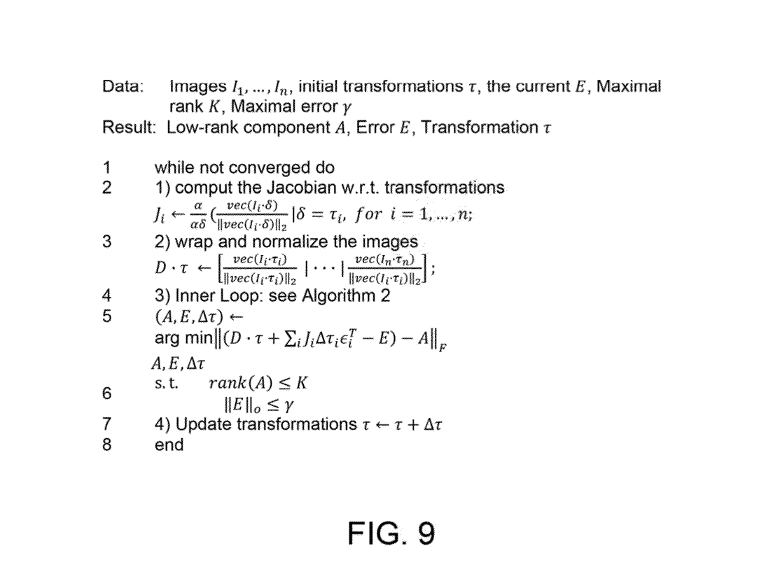

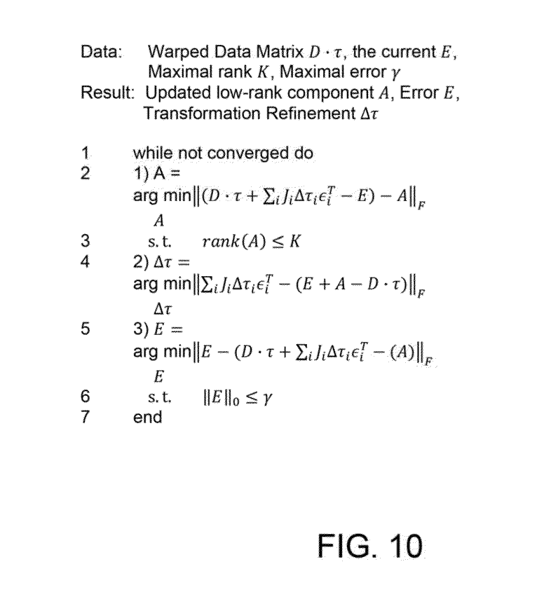

An exemplary embodiment of the resulting technique is illustrated in FIG. 8. The technique may use an iterative technique that includes calculating the Jacobian and warp images (D·τ) 500, with A, E and Δτ being fixed. Then the technique may update the estimate of the low rank component A 510, all else being held constant. The technique may update the estimate of the alignment refinement Δτ 520, all else being held constant. The technique may update the estimate of the error component E 530, all else being held constant. The process of updating A 510, Δτ 520, and E 530 may be repeated, as desired. The estimate of transformation τ is updated 540. The entire process may be repeated, such as until the values sufficiently converge. Referring to FIG. 9 and FIG. 10, an exemplary technique is illustrated in more detail.

The aforementioned process may include a low-rank approximation that is directly given by truncated Singular Value Decomposition (SVD) approximation to D·τ+Σᵢ₌₁ⁿJᵢεᵢ^{T}−E Since the transformations are applied to each image individually, the unconstrained minimization problem may be a least square problem with closed-form solution for each image. One may use the Moore-Penrose pseudoinverse, if desired. The error detection problem with l₀ norm constraints may also be solved efficiently by principally using a quantile computation. It is noted that since relaxations are not applied to the constraints, the formulation is non-convex and may get trapped into local-minima. As a result, the system may initialize the solution based on a convex approximation for a few iterations, if desired.

If desired, the use of multiple template images for the data matrix D may improve defect detection performance. One of the reasons is that if the system just decomposes the image matrix with two images without using any prior knowledge, then the defects may be positioned in the error image of the input or the template as the objective function will be the same. Also, it is often the case that the errors are distributed in weaker form in both components. However, when using (n−1) identical (or substantially the same) template images, the low-rank component will be guided towards the template, since turning on one element of the error image of the template means (n−1) times the cost. This technique results in the error component substantially containing any defects. Thus one may simply refer to the error image of the input with stronger error response.

The preferred framework uses a robust rank minimization approach, which works well assuming sparse errors in the whole data matrix. With preferably only two images, when the defect is big (say m % of the input, where m is greater than 80), it is less sparse in terms of the whole matrix (still m/2% of the whole matrix) However, as the system may use (n−1) template images, the defects now possess m/n % of the data entries.

Image down-sampling is often used for speed-up while sacrificing performance to some extent in image processing and computer vision areas. One reason for this trade-off might be the inaccuracy of feature extraction in low-resolution image. However, the preferred technique does not need any feature extraction and works on the pixel level, thus eliminating such issue. Also, the system may work in the down-sampled domain for both speed-up and accuracy improvement. This improvement using down-sampling may principally arise from two factors. First the iterative linearization of transformation works well when the initial misalignment is not too large. The initial misalignment is also significantly reduced in terms of pixel numbers, thus is more likely to recover large initial misalignment. Second, down-sampling may reduce very small imperfections in the template image(s).

The preferred technique has two explicit parameters, namely K and γ. They are readily set by an operator as they have clear meaning in the system context. As for K, the rank constraint of low-rank matrix, may be simply set to be 1, as one would expect the defect-free image to be linearly correlated with the low-rank component of the template. As for γ, the cardinality constraint on errors, one may set it to be 1/n, as one largely expects only entries in the input image are labels as outliers.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for image processing comprising:
(a) receiving a model image;
(b) receiving an input image;
(c) registering said input image with said model image;
(d) determining a modified input image that includes
(1) a first component that is substantially free of error components with respect to said model image;
(2) a second component that is substantially free of non-error aspects with respect to said model image;
(e) determining an improved alignment of said modified input image with said model image;
(f) wherein said improved alignment and said first and second components are determined jointly.

2. The method of claim 1 further comprising determining a modified model image that includes a first component that is substantially free of error components.

3. The method of claim 2 wherein said modified model image includes a second component.

4. The method of claim 3 wherein said first component of said modified input image is constrained to have a linear relationship with said first component of said modified model image.

5. The method of claim 1 wherein said second component of said modified input image is constrained using an error measurement.

6. The method of claim 5 further comprising determining a modified model image that includes a first component that is substantially free of error components.

7. The method of claim 6 wherein said modified model image includes a second component.

8. The method of claim 7 wherein said second component of said modified input image is constrained to have a linear relationship with said second component of said modified model image.

9. The method of claim 7 wherein said second component of said modified input image and said second component of said modified model image are constrained using an error measurement.

10. The method of claim 1 wherein said second component of said modified input image substantially contains changes in characteristics of objects in said input image with respect to said model image.

11. The method of claim 10 wherein said changes in characteristics of said objects correspond to defects.

12. The method of claim 10 wherein said changes in characteristics of said objects correspond to motion.

13. The method of claim 1 wherein said jointly improved aligning is based upon a direct matrix factorization and alignment refinement.

14. The method of claim 13 wherein said direct matrix factorization and alignment refinement is iterative.

15. The method of claim 14 wherein said direct matrix factorization and alignment refinement includes a low-rank representation of a template guided matrix.

16. The method of claim 1 wherein said second component of said modified input image is sparse.

17. The method of claim 1 wherein said image processing is based upon a single input image and a single model image.

18. The method of claim 1 wherein said modified input image includes a third component that is substantially noise.

19. The method of claim 7 wherein said modified model image includes a third component that is substantially noise.

20. The method of claim 1 wherein said image processing is free from using training data.

21. The method of claim 1 wherein said image processing is free from using manual alignment.

22. The method of claim 1 wherein said model image has a greater size than said input image.

23. The method of claim 1 wherein said jointly improved aligning is a constrained optimization technique based upon a rank constraint and a maximal number of non-zero error entries.
